(19) United States
(12) Patent Application Publication
(10) Pub. No.: US 2014/0314472 A1
(43) Pub. Date: Oct. 23, 2014

(54) HOLLOW PROFILE CONNECTION - GUSSET ELEMENT

(71) Applicant: MAGNA STEYR Fahrzeugtechnik AG & Co KG, Graz (AT)

(72) Inventors: Bernhard HOFER, Graz (AT); Harald ZACHNEGGER, Graz (AT)

(73) Assignee: MAGNA STEYR Fahrzeugtechnik AG & Co KG, Graz (AT)

(21) Appl. No.: 14/255,338

(22) Filed: Apr. 17, 2014

(30) Foreign Application Priority Data
Apr. 18, 2013 (EP) 13164329.8

(51) Int. Cl. B23K 20/12; F16B 7/00

(52) U.S. Cl. CPC B23K 20/129; F16B 7/00
USPC 403/267

(57) ABSTRACT

A hollow profile connection to connect at least two hollow profiles. The connection includes a gusset part, the end pieces of which are insertable into the hollow profiles. At least the end pieces of the gusset part are assigned to the ends of the hollow profiles have a profile formed by webs or ribs. The gusset part and hollow profile are connected to each other by a friction-stir weld which run along the ribs or webs of the gusset part.

### CROSS-REFERENCE TO RELATED APPLICATIONS

The present application claims priority under 35 U.S.C. §119 to European Patent Application No. EP 13164329.8 (filed on (Apr. 18, 2013), which is hereby incorporated by reference in its entirety.

### TECHNICAL FIELD

Embodiments relate to a hollow profile connection to connect at least two hollow profiles, and which comprises a gusset part, the end pieces of which are insertable into the hollow profiles. The at least the end pieces of the gusset part which are assigned to the ends of the hollow profiles have a profile formed by webs or ribs. The gusset part and the hollow profiles are connected to each other by a friction-stir weld. The connections are produced by friction-stir welding between hollow profile and gusset part run along the ribs or webs of the gusset part.

### BACKGROUND

Metallic hollow profiles are frequently and effectively connected by way of gusset plates which are arranged between the profiles and are subsequently connected thereto by welds. For weight reasons, in motor vehicle manufacturing, use is generally made of hollow profiles consisting of aluminium, and the gusset plates are likewise manufactured from aluminium.

During the formation of conventional welds, a high amount of heat is applied, causing distortion of the assembly. The dimensional accuracy is negatively influenced. In order to produce flat and therefore stable connections, holes have to be made in the plates in order to form plug or slot welds. Furthermore, during the welding, there are spatters which have to be removed in a complicated manner from the surfaces.

By way of friction-stir welding, or indirect friction-stir welding, plates composed of aluminium may be connected to one another with a low application of heat. The plates are placed one above the other and the friction-stir welding tool is placed onto the upper side of the one plate under pressure and moved along a designated connecting line. A connection is produced. However, use in the case of hollow profiles is not possible.

German Patent Publication No. DE 10 2010 018 504 A1 discloses a method for producing a hollow profile using friction-stir welding. A semi-finished component consisting of an aluminium alloy is welded along a connecting line by way of a weld formed by friction-stir welding. During the welding, a counter holder which supports the welding zone from the lower side is introduced into the profile.

The welding of two plates lying in one plane along the contact line thereof by way of friction-stir welding is described by German Patent Publication No. DE 10 2010 003 742 A1.

The connection of two plates adjacent to each other in a plane on a hollow profile is shown in Japanese Patent Publication No. JP 2004 261 859 A. By way of a tool, the plates are welded to each other along the border, which forms a gap, by way of friction-stir welding, at the same time, a metal strip is also placed into the gap.

The production of a hollow profile part by joining together two shaped parts and by connecting the shaped parts along the joining line by way of friction-stir welding is shown in Japanese Patent Publication No. JP 2001 233 208 A.

A method for producing a low-twist frame structure by lap-welding is disclosed in German Patent Publication No. DE 100 11 593 A1. A T-shaped gusset piece which is inserted into the tube ends to be connected serves here as a connecting element for three tubes. The tube end region overlapping the inserted gusset piece is friction-stir welded by way of a revolving tool such that the tube material may be connected to the material of the gusset piece in the context of a friction-stir weld.

Japanese Patent Publication No. JP 11 226 759 A also discloses the connection of profile parts by way of friction-stir welding. The parts which are to be connected to one another are oriented with respect to one another, and a pressure piece absorbing the compressive forces occurring during the friction-stir welding is welded at the same time in the contact region of the parts.

### SUMMARY

Embodiments relate to a hollow profile connection in a design which is enhanced in relation to the known types.

In accordance with embodiments, in order to connect at least two hollow profiles, a gusset part is provided, the end pieces of which are insertable into the ends of the hollow profiles. The end pieces of the gusset part which are assigned to the hollow profile ends have a profile formed by webs or ribs. The gusset part and hollow profile part are connected to each other by a friction-stir weld. The connections, which are produced by friction-stir welding, between hollow profile and gusset part run along the ribs or webs, i.e., in the direction of extent of the respective hollow profile precisely in the region which is supported in a correspondingly pressure-tight manner because of the web or the rib of the gusset part. The connections produced by friction-stir welding may be designed to be punctiform and/or continuous and/or linear.

The profiled parts of the gusset part that are introduced into the hollow profiles are preferably designed as an X-, star- or H-shaped cross-section, the external dimensions thereof being matched to the internal contour of the hollow profile. After insertion into the hollow profile, the webs or ribs protruding substantially radially outwards in a designated number are in contact with the inner side of the hollow profile and thus make it possible to absorb pressure exerted from the outside during the production of the connection by way of friction-stir welding.

The hollow profiles are in particular in the form of square, rectangular or hexagonal profiles or profile bars, the ends of which that are assigned to the gusset part are open.

In accordance with embodiments, the hollow profiles may be connected to one another by the gusset part and at least one gusset plate fitted from the outside. The gusset plate makes contact with the hollow profiles on the outside thereof in a region which intersects with the insertion depth of the profiled ends of the gusset part into the respective hollow profile. It is therefore possible, by way of the connections to be formed along the webs or ribs of the profiled gusset part, to connect the gusset plate, the hollow profile and the gusset part to one another.

The gusset plate may be connected to the hollow profile and the inserted profiled end of the gusset part by way of at least one friction-stir weld. The friction-stir weld runs along at least one of the ribs or webs which may be in contact with the hollow profile in the interior thereof. A plurality of friction-stir welds may be formed along the ribs which may be in contact with the hollow profile part on the inside.

In accordance with embodiments, the gusset plate is also connected directly to the gusset part or the ribs of the gusset part. Connections, which may be produced by friction-stir welding, between gusset plate and gusset part may therefore also be possible outside the hollow profile parts. Provision may be made here for connections between gusset plate and gusset part to be formed along all of the ribs of the gusset part.

The gusset part which connects the at least two hollow profiles to each other may be surrounded by two gusset plates, wherein the latter, in the form of two half shells, may be fitted together encompassing the ends of the hollow profiles and may be then connected. The friction-stir welds may be formed here in the region of the hollow profile overlap along the ribs of the inserted profiled ends of the gusset part. In addition, friction-stir welds may be also formed in the direct contact region of the gusset plates. The latter may have one or more regions which may be designed as contact and connecting strips and in which the friction-stir welds serving for the connection may be formed.

The gusset part in accordance with embodiments may serve for connecting two, three or more hollow profiles. In the case of three hollow profiles, the gusset part may have a T-shaped cross-section.

Furthermore, provision may be made for the hollow profiles to have devices which limit the insertion depth of the respective end piece of the gusset part into the hollow profile. This may be, in particular, a pin or a screw which is insertable into the hollow profile.

### DRAWINGS

Embodiments are described by way of example below with reference to the drawings.

FIG. 1 illustrates a perspective view of a connection of three hollow profiles by way of a gusset part, in accordance with embodiments.

FIG. 2 illustrates a section through a hollow profile with the inserted profiled end piece of the gusset part and the connections formed by friction-stir welding.

FIG. 3 illustrates a perspective view of a connection of three hollow profiles by way of a gusset part and two additional gusset plates, in accordance with embodiments.

FIG. 4 illustrates a section through a hollow profile with the inserted profiled end piece of a gusset part, two gusset plates encompassing the hollow profile on the outside and the connections formed by friction-stir welding.

FIG. 5 illustrates a perspective view of a connection of three hollow profiles by way of a gusset part and two additional gusset plates, the two gusset plates may not yet fitted onto the hollow profile or the gusset part.

FIG. 6 illustrates the direct connection of the gusset plate to the ribs of the gusset part.

### DESCRIPTION

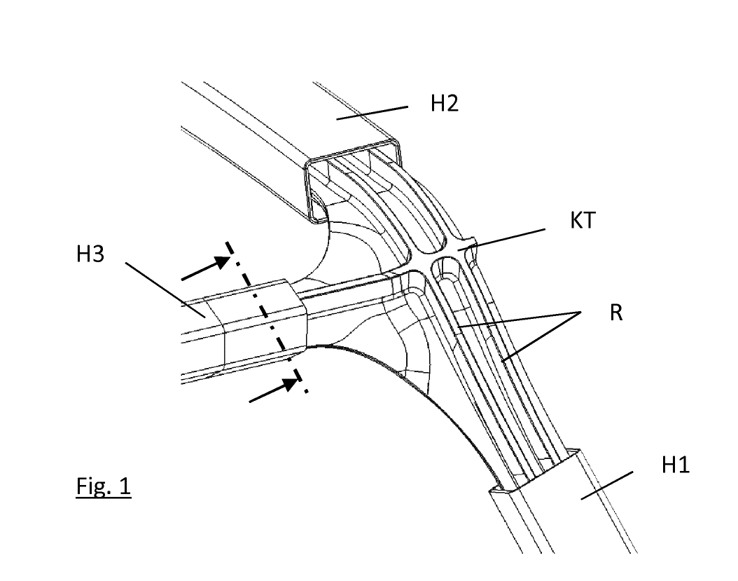

FIG. 1 illustrates a connection of three hollow profiles H1, H2, H3 by a T-shaped gusset part KT inserted into the ends of the hollow profiles H1, H2, H3. The gusset part KT is manufactured as a cast part composed of aluminium or an aluminium alloy and has, as the ends thereof, profiles which are matched to the cross sections of the hollow profiles H1, H2, H3 to be received and which are formed with ribs R. The hollow profiles H1, H2, H3 may likewise be manufactured from aluminium or an aluminium alloy.

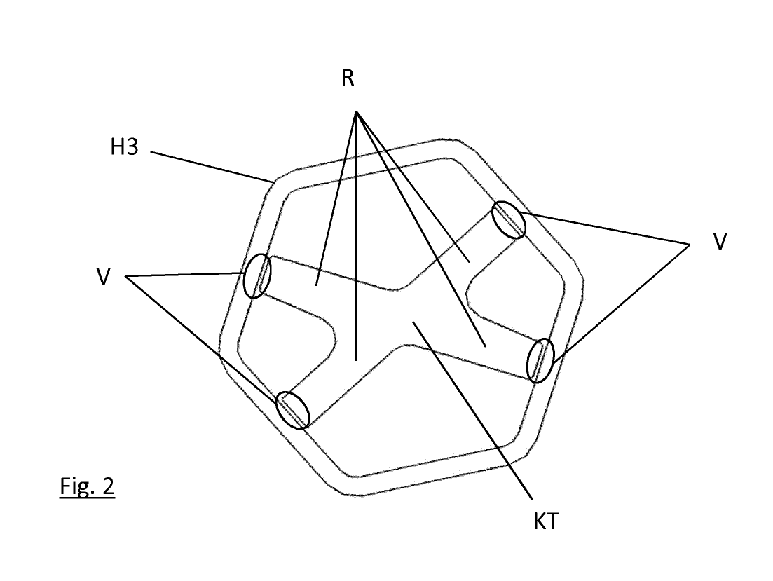

FIG. 2 illustrates a cross-section through the hollow profile H3 together with the received profiled end of the gusset part KT. The profile of the cross-section is indicated in FIG. 1.

The end of the gusset part KT profiled in the shape of an X is inserted into the hollow profile H3. The ribs R of the gusset part KT that form the X are in contact with the inner surface of the hollow profile H3. In the contact regions, connections V, which are produced by friction-stir welding, are formed between the wall of the hollow profile H3 and the rib R present in the inside of the hollow profile H3.

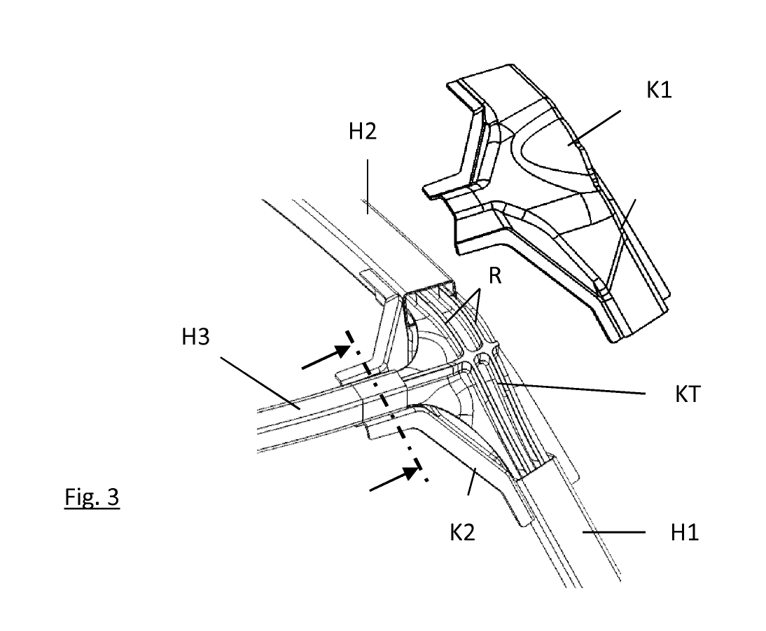

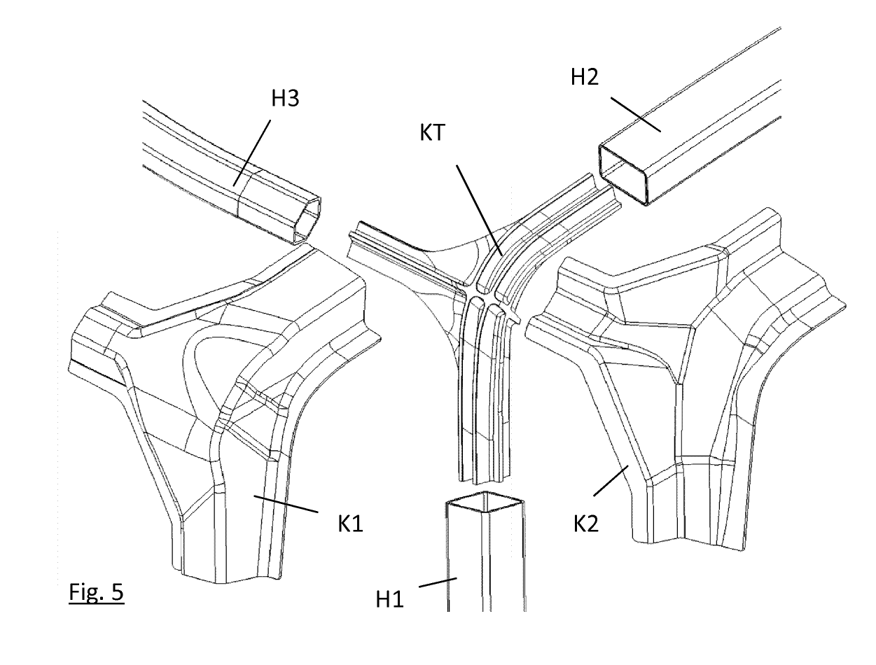

FIGS. 3 and 5 illustrate an embodiment in which the connection of the hollow profiles H1, H2, H3 takes place by way of a gusset part KT and two gusset plates K1, K2 fitted together in the manner of half shells. In the fitted-together state, the gusset plates K1, K2 encompass the hollow profiles H1, H2, H3 in the region which is formed by the profiled ends of the gusset part KT. The gusset plates K1, K2 are connected to the hollow profiles H1, H2, H3 and the gusset part KT by way of connections V which are formed by friction-stir welding and run in the region of and along the ribs R of the gusset part KT.

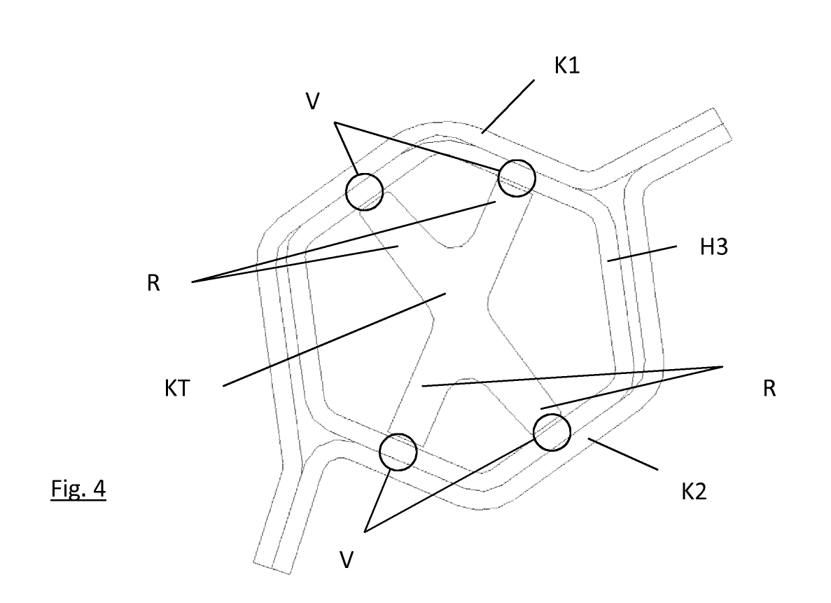

FIG. 4 illustrates a section through the hollow profile H3 with the end of the gusset part KT which is profiled by the ribs R and with the two gusset plates K1, K2 encompassing the hollow profile H3. This section is indicated in FIG. 3. The profile of the connections V formed by friction-stir welding is illustrated in FIG. 4 in the manner corresponding to the orientation of the ribs R of the gusset part KT. The ribs R are therefore connected to the hollow profile H3 and to the gusset plates K1, K2. Furthermore, the ribs R have absorbed the pressure exerted on the hollow profile H3 during the formation of the friction-stir welds.

FIG. 4 further illustrates that the profiled end piece of the gusset part KT and the hollow profile H3 is not connected to the gusset plates K1, K2 on all of the outer flanks of the hexagonal hollow profile H3, and, in the non-connected regions, the gusset plates K1, K2 are at a distance from the hollow profile H3. This results in a compensation for tolerances of the components.

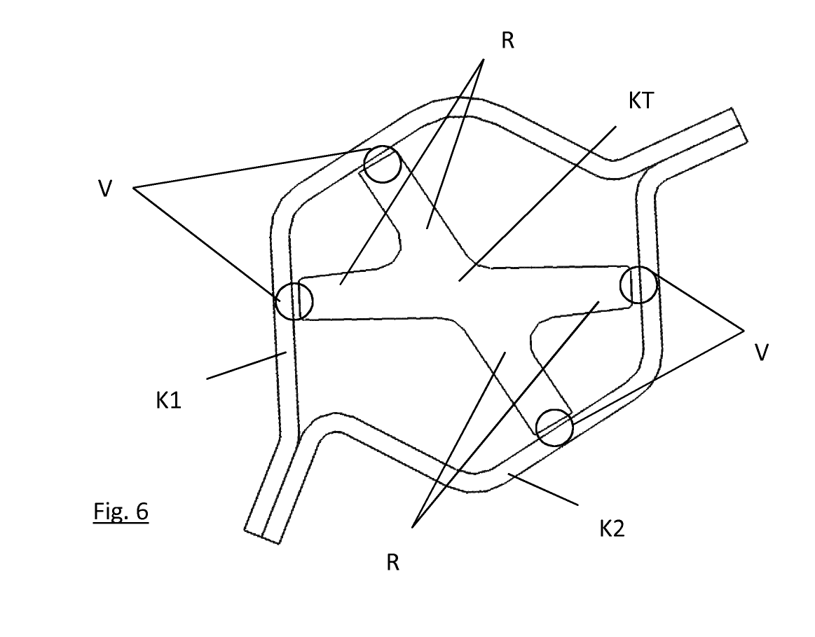

FIG. 6 illustrates how the gusset plates K1, K2 may also be connected directly to the gusset part KT or the ribs thereof. The connections V fix the gusset plates K1, K2 in a region in which the gusset part KT is no longer surrounded by the hollow profile H3. Correspondingly, the gusset part KT holds the gusset plates K1, K2 via the ribs R and the connections V formed by way of friction-stir welding.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### LIST OF REFERENCE SIGNS

H1 Hollow profile

H2 Hollow profile

H3 Hollow profile

KT Gusset part

K1 Gusset plate

K2 Gusset plate

R Rib

V Friction-stir weld connection

What is claimed is:

1. A connector to connect at least two hollow profiles, the connector comprising: a gusset part having end pieces which are insertable into the at least two hollow profiles, wherein at least the end pieces of the gusset part which are assigned to the ends of the at least two hollow profiles have a profile formed by webs or ribs, wherein the gusset part is connected to the at least two hollow profiles by a friction-stir weld which run along the ribs or webs of the gusset part.

2. The connector of claim 1, wherein the gusset part has, at least in the end pieces, an X-, H- or star-shaped cross-section formed by the webs or ribs.

3. The connector of claim 1, wherein the gusset part is composed of an aluminium or an aluminium alloy cast component.

4. The connector of claim 1, wherein the at least two hollow profiles are composed of aluminium or an aluminium alloy.

5. A connector to connect at least two hollow profiles, the connector comprising:
a gusset part having end pieces which are insertable into the at least two hollow profiles, wherein at least the end pieces of the gusset part which are assigned to the ends of the at least two hollow profiles have a profile formed by webs or ribs, wherein the gusset part is connected to the at least two hollow profiles by a friction-stir weld which run along the ribs or webs of the gusset part; and
a gusset plate connected to the ends of the hollow profiles via friction-stir welding which run along the ribs or webs of the gusset part.

6. The connector of claim 5, wherein the gusset part has, at least in the end pieces, an X-, H- or star-shaped cross-section formed by the webs or ribs.

7. The connector of claim 5, wherein the gusset part is composed of an aluminium or an aluminium alloy cast component.

8. The connector of claim 5, wherein the at least two hollow profiles are composed of aluminium or an aluminium alloy.

9. The connector of claim 5, wherein in which the connections along the ribs or webs of the gusset part take place only in a region in which the at least two hollow profiles are overlapped by a gusset plate and gusset part.

10. The connector of claim 5, wherein the gusset plate or the gusset plates is or are also connected to the gusset part outside the hollow profiles.

11. A connector to connect at least two hollow profiles, the connector comprising:
a gusset part having end pieces which are insertable into the at least two hollow profiles, wherein at least the end pieces of the gusset part which are assigned to the ends of the at least two hollow profiles have a profile formed by webs or ribs, wherein the gusset part is connected to the at least two hollow profiles by a friction-stir weld which run along the ribs or webs of the gusset part; and
a pair of gusset plates connected to the ends of the hollow profiles via friction-stir welding which run along the ribs or webs of the gusset part, the gusset plates having half shells configured for connection to each other.

12. The connector of claim 11, wherein the gusset part has, at least in the end pieces, an X-, H- or star-shaped cross-section formed by the webs or ribs.

13. The connector of claim 11, wherein the gusset part is composed of an aluminium or an aluminium alloy cast component.

14. The connector of claim 11, wherein the at least two hollow profiles are composed of aluminium or an aluminium alloy.

15. The connector of claim 11, wherein in which the connections along the ribs or webs of the gusset part take place only in a region in which the at least two hollow profiles are overlapped by a gusset plate and gusset part.

16. The connector of claim 11, wherein the gusset plate or the gusset plates is or are also connected to the gusset part outside the hollow profiles.
